(19) United States
(12) Patent Application Publication
(10) Pub. No.: US 2013/0288100 A1
(43) Pub. Date: Oct. 31, 2013

(54) HOUSING FOR ACCOMMODATING A FLAT ELECTROCHEMICAL CELL

(71) Applicants: Felix Dunkel, Hoyerswerda (DE); Tim Schaefer, Harztor (DE)

(72) Inventors: Felix Dunkel, Hoyerswerda (DE); Tim Schaefer, Harztor (DE)

(73) Assignee: Li-Tec Battery GmbH, Kamenz (DE)

(21) Appl. No.: 13/877,744

(22) PCT Filed: Oct. 4, 2011
(86) PCT No.: PCT/EP2011/004944

§ 371 Date: Jun. 24, 2013

(30) Foreign Application Priority Data
Oct. 4, 2010 (DE) 10 2010 047 453.3

(51) Int. Cl. H01M 2/02; B26D 1/00; H01M 10/50

(52) U.S. Cl. CPC H01M 2/0207; H01M 10/504; B26D 1/00
USPC 429/120; 429/163; 429/153; 83/13

(57) ABSTRACT

A housing (1) for accommodating at least one flat electrochemical cell (2), which has a seal seam (3) extending at least regionally along the edge of said cell, comprises two housing side walls (4) which are arranged substantially parallel to one another and which are provided, in the mutually opposite inner surfaces thereof, with a pair of incisions (5) situated opposite one another for each cell (2) that is to be accommodated, said incisions being designed to accommodate the at least one seal seam (3) of the particular cell (2). The housing (1) here is preferably formed of a foam material.

The invention relates to a housing for at least one flat electrochemical cell comprising a extending at least regionally along its edge, an arrangement of a plurality of such cells in such a housing and a method of producing such a housing or such an arrangement.

Electrochemical energy stores, hereinafter also referred to as electrochemical or galvanic cells, are frequently produced in the form of flat, stackable units from which batteries for various applications can be produced by combining a plurality of such cells. For the mechanical fixing of the cells within a stacked arrangement of cells of this kind, arrangements of such cells are proposed in DE 10 2009 005 124 A1, for example, in which the cells are held in frames which are provided with suitable structural elements, so that the cells are thereby combined into mechanically stable assemblies comprising a plurality of cells.

The present invention is based on the object of specifying a technical teaching on the mechanical fixing or encasement of flat electrochemical cells, which avoids or overcomes the disadvantages and limitations of known solutions where possible.

This problem is solved by a housing for accommodating at least one flat electrochemical cell comprising a seal seam extending at least regionally along its edge according to claim 1, by an arrangement of a plurality of such cells according to claim 9 and by a method of producing such a housing or such an arrangement according to claim 12. The subclaims relate to advantageous further developments of the invention.

According to the invention, there is provided a housing for accommodating at least one flat electrochemical cell comprising a seal seam extending at least regionally along its edge, wherein the housing comprises two housing side walls which are arranged substantially parallel to one another and which comprise, in the inner surfaces thereof, a pair of incisions situated opposite one another for each cell that is to be accommodated, the incisions being designed to accommodate the at least one seal seam of the respective cell.

A housing within the meaning of the present invention refers in this case to any device which is suitable for shielding an electrochemical cell or an assembly of a plurality of electrochemical cells from unwanted or interfering external influences and/or protecting the environment of the electrochemical cell or the assembly of such electrochemical cells from unwanted influences, which can arise through the operation of such cells. A housing of this kind preferably prevents or impedes in this case unwanted mass transport or mass exchange or energy exchange between the inside of the housing and the environment.

An electrochemical cell in this context should be understood to mean an electrochemical energy store, in other words a device which can store energy in chemical form, can deliver energy in electrical form to a consumer and can preferably also receive it in electrical form from a charging device. Important examples of such electrochemical energy stores are galvanic cells or fuel cells.

A flat electrochemical cell in this context is taken to mean an electrochemical cell, the outer form of which is characterized by two substantially parallel surfaces, the perpendicular distance between these being shorter than the mean length of the cell measured parallel to these surfaces. The electrochemically active components of the cell are arranged between these surfaces, frequently encased in a packaging or a cell housing. Cells of this kind are frequently surrounded by a multi-layer packaging film, which comprises a seal seam on the edges of the cell packing, said seal seam being formed by a permanent connection or sealing of the packaging film in the area of the seal seam. Cells of this kind are frequently also referred to as pouch cells or as coffee bag cells.

The construction of the pair of mutually opposite incisions provided to accommodate the at least one seal seam of the respective cell relates to the design, size and arrangement of these incisions which are suitable for this purpose.

According to a preferred embodiment of the invention, a housing is provided in which at least one housing wall disposed between the two housing side walls is provided, which comprises an incision in its inner surface for each cell that is to be accommodated, said incision being designed to accommodate the at least one seal seam of the at least one cell. A housing wall of this kind disposed between the two housing side walls preferably forms the base of the housing and/or the top of the housing. In other embodiments of the invention, a further housing wall disposed between the two housing side walls may also be an internal housing wall, which separates from one another a plurality of layers of electrochemical cells, which are accommodated in a housing.

A further preferred embodiment of the invention provides at least one internal housing wall disposed between two incisions, which is preferably disposed between two adjacent electrochemical cells. Internal housing walls of this kind are preferably used to separate the adjacent electrochemical cells thermally and/or mechanically from one another, in order to avoid or prevent unwanted interactions between adjacent electrochemical cells wherever possible.

According to further preferred embodiments of the invention, at least one of the housing walls, internal housing walls or housing side walls is produced from a compressible, particularly preferably an elastic material. Particularly preferred in this case are materials made of a cellular material, preferably a polyethylene expanded plastic. Such materials are particularly suitable for absorbing mechanical vibrations, impacts or other potentially damaging influences and reducing or eliminating the effect thereof on the electrochemical cells arranged in the housing.

According to further preferred embodiments of the invention, it is provided that the housing is configured as an encasement enclosing the entire cell body, preferably on the battery module level, wherein vibrational or heat loads unavoidable to the application are insulated or at least partially absorbed. It is particularly preferable for the housing block or the housing walls, internal housing walls or housing side walls to be provided with pouches to be configured in material terms such that an optimum pressure for cell operation can be maintained over the service life of the cell, even in an ageing cell, through the partial elasticity of the material. With so-called cell breathing of 3/10, for example, or an increase in thickness through ageing, the optimum pressure can thereby be maintained, as a result of which in particular the service life of cells containing separators made of Separion, the ageing process and thus the service life of the cell can be positively influenced. This is preferably achieved through the flexible pressure of the cell walls on the housing walls, internal housing walls or housing side walls provided with pouches during the ageing process with a simultaneously consistent lightweight design.

According to a further preferred embodiment, the housing or the housing walls, internal housing walls or housing side walls are preferably outwardly protected from unwanted influences by means of a multi-layer composite material, a hybrid material or a fibre composite material or by means of similar lightweight construction materials. Effective heat-conducting materials are preferably used for this. By choosing suitable fibre composite materials for this purpose, a high degree of strength can be achieved and guaranteed, so that particles or penetrating objects on or in the group of cells do not lead to short-circuits or damage.

An elastomer is preferably used as the basic or matrix material for this fibre composite material. The reinforcing fibres in this material are preferably multidirectional, preferably selectively aligned or unidirectionally aligned. By means of a multidirectional alignment of the reinforcing fibres, an increase in the component strength of the housing walls is preferably achieved and the reliability of the battery housing thereby increased. By means of an at least regionally selective, e.g. a unidirectional alignment of the reinforcing fibres, the deforming of the housing walls, internal housing walls or housing side walls is preferably influenced. A selective, locally different deforming of the housing walls, internal housing walls or housing side walls is thereby preferably achieved. Through this kind of selective deforming of the housing walls, internal housing walls or housing side walls, it is particularly achieved that said walls extend into existing cavities or recesses which surround the battery housing. By means of a selective deforming of this kind, uncontrolled contact with objects surrounding the battery housing, e.g. frame parts or other battery housings, is preferably avoided and the safety of the battery housing is thereby increased.

The reinforcing fibres of this fibre composite material for this side wall according to the invention are preferably made of a plastic. Said plastic preferably has an expansion behaviour which differs from the basic material. These reinforcing fibres are preferably made of nylon or aramid. The reinforcing fibres may preferably also be made of a material from a material group other than plastic, such as, for example, glass fibres, metal fibres, ceramic fibres or carbon fibres. The reinforcing fibres preferably have a thickness from 1 μm to 1,000 μm, preferably from 10 μm to 100 μm and particularly preferably from 20 μm to 40 μm. The expansion behaviour of these reinforcing fibres may preferably be influenced by their geometry, e.g. by the cross-sectional surface situated perpendicular to the main tension direction, or preferably by their modulus of elasticity. The different expansion behaviour of the reinforcing fibres and of the basic material means that the deformation characteristics of this side wall can be influenced and the safety of the battery housing thereby increased.

The side wall is preferably made at least partially of a plastic with a breaking elongation of 100% to 1,000%, such as polyolefin, for example, of a plastic with a breaking elongation of 50% to 500%, such as polyamide, for example, or of a plastic with a breaking elongation of 5% to 80%, such as polycarbonate, for example. The side wall is preferably made at least partially of a plastic from the polyethylene propylene diene (EPDM) group. This plastic is preferably not chemically attacked by the constituents of an electrochemical energy storage device or by the reaction products thereof or decomposed by these. A coating or a protective device preferably prevents reactive constituents from coming into contact with this side wall. By choosing a suitable plastic for the side wall, reactive substances are preferably prevented from escaping from the battery housing, so that the safety is thereby increased.

In a fibre composite material, the thermal conductivity is preferably achieved by a high proportion of heat-conductive fibres, which are preferably made of a material having the aforementioned heat conductivity properties. A fibre composite material preferably comprises a fibre proportion of 30 to 95% by vol., preferably of 40 to 80% by vol. and particularly preferably of 50 to 65% by vol. This is preferably a material with a high thermal conductivity, preferably with a thermal conductivity at 20° C. of 40 to 1000 W/(K*m), preferably 100 to 400 W/(K*m) and particularly preferably approx. 220 W/(K*m). This material preferably includes aluminium as an essential component; further components may preferably be manganese, magnesium, copper, silicon, nickel, zinc and beryllium.

A hybrid material within the meaning of the invention is understood to be a material, regions of which are made of a plastic, preferably a fibre-reinforced plastic, and at least regions of which are preferably made of a metal material. In those regions in which the hybrid material is made of metal, it preferably has good heat-conducting properties; in those regions in which this material is made of fibre-reinforced plastic, it preferably has good heat insulation properties. This heat conductivity is preferably below 0.5 W/(K*m), preferably below 0.2 W/(K*m) and particularly preferably below 0.1 W/(K*m), at 20° C. in each case. As a result of the favourable heat conductivity properties and, in the case of a hybrid material, the good insulation properties of the battery housing too, the temperature balance of the energy storage devices can easily be influenced and the operational safety thereby improved.

The housing according to the invention or the arrangement according to the invention preferably comprises a cell pressure distribution layer. The cell pressure distribution layer is particularly used for the areal distribution of a force or a pressure, which is exerted by a foreign body on this cell pressure distribution layer. In particular, the cell pressure distribution layer preferably separates the battery cell from a foreign body. A cell pressure distribution layer preferably includes at least one material from the following group made up of ferrous alloys, steel, lightweight metals such as aluminium, titanium or magnesium, particularly cross-linked plastics, plastics with fillers and/or woven/non-woven fabrics, particularly with carbon fibres, glass fibres and/or aramid fibres.

A cell pressure distribution layer preferably comprises honeycomb structures, particularly with aramid fibres and/or a metal film, wherein the longitudinal axes of the honeycombs are particularly preferably disposed in the direction of the influencing foreign body. The honeycombs are preferably closed with a cover layer in the longitudinal direction. The cell pressure distribution layer preferably comprises a rib or a stud, which particularly preferably extends in the direction of an anticipated foreign body. The cell pressure distribution layer is preferably disposed only in predetermined regions of the housing or of the arrangement, particularly preferably in regions which can be expected to be at risk from a foreign body with a particularly small end face. A cell pressure distribution layer is preferably designed to be electrically conductive at least regionally, particularly by means of a metal coating and/or a metal wire.

The housing preferably comprises at least regionally a material from the following group, which comprises: ferrous alloys, steel, lightweight metals such as aluminium, titanium or magnesium, plastics such as in particular PP, PA or PE which are particularly cross-linked and which are particularly reinforced with fillers and/or woven/non-woven fabrics, particularly with glass and/or aramid fibres. The housing preferably has a honeycomb structure at least regionally, particularly preferably with aramid fibres and/or with a metal film, wherein the longitudinal axes of the honeycombs are particularly preferably disposed in the direction of the influencing foreign body.

According to further preferred embodiments of the invention, it is envisaged that the material of the housing walls, internal housing walls or housing side walls will be provided with fire-retardant additives or with extinguishing agents or with extinguishing agent additives, so that in the event of a fire in a cell, an extinguishing action can be achieved as close as possible to the source of the fire and preferably also without influence from outside.

In this context, a fire is taken to mean any event in which the energy store or parts of the energy store or its environment are converted or decompose during an unwanted chemical reaction. Fires in this sense are particularly exothermic chemical reactions in elements or components of an energy store or its environment, which frequently occur as a consequence of overheating of the energy store or its components.

An extinguishing agent in this context should be taken to mean a substance or a mixed substance which produces an extinguishing effect, in other words preferably an inhibiting effect on fires and/or prevents or impedes the emergence of fires. An extinguishing effect in the context of the present invention should preferably be taken to mean an effect which counteracts a fire, i.e. which is able to prevent or mitigate the consequences or development of a fire. Important examples of extinguishing agents or their preferred constituents are substances which remove from the source of a fire a chemical reaction partner, without which the fire cannot be sustained, or which inhibit a chemical reaction required to initiate or to maintain a fire. The extinguishing agents are preferably produced by mixing an extinguishing agent additive or a fire-retardant additive with an extinguishing agent or with a carrier substance.

So-called D extinguisher powders (also: metal fire powders, metal fire extinguisher powders, M powders) or a so-called ABC extinguisher powder, in other words preferably an extinguishing agent additive or a fire-retardant additive which consists primarily of ultra-finely ground ammonium phosphate and ammonium sulphate, can preferably be considered as fire-retardant additives in connection with the present invention. In this context, preferred D extinguisher powders preferably consist primarily of ultra-finely ground alkali chlorides (often sodium chloride). A particular feature of these substances is their high reaction and temperature stability.

Preferred extinguishing agent additives or fire-retardant additives in the context of this invention are so-called gelling agents, which are formed in connection with other materials, extinguishing agents or carrier substances, such as preferably water, preferably adhesive and preferably viscous gels or viscoelastic fluids, which preferably stand out due to their high adhesive power on burning objects and the surfaces thereof. Gelling agents are preferred examples of extinguishing agent additives which are preferably based on so-called super-absorbers and which are preferably provided as powders or solid materials or also as emulsions. Super-absorbers are frequently able to absorb a multiple of their weight or volume in water or another carrier substance. Water-based gels, which are formed by corresponding super-absorbers by mixing with water, have the advantage compared with traditional foam layers that an airtight barrier layer is formed, which remains in existence longer than with traditional foam layers and which delivers significantly less water to the burnt material.

In connection with the description of the present invention, a viscoelastic fluid should be understood to mean a fluid which exhibits the property of viscoelasticity. A(n) (ideal) fluid is understood to be a substance which offers no resistance to slow shearing of any order (roughly speaking). A distinction is made between compressible fluids (gases) and non-compressible fluids (liquids). The generic term “fluid” is used because most laws of physics apply equally to gases and liquids (roughly speaking) and many of their properties differ only quantitatively, but not essentially qualitatively, from one another. Real fluids may be divided according to their behaviour into “Newtonian fluids” with the flow mechanics describing them and non-Newtonian fluids with the rheology describing them. The difference here lies in the flow behaviour of the medium, which is described by the functional relationship of the shear stress or transverse stress and the strain rate or shear rate.

Viscoelasticity is the term used to denote the time-dependent, temperature-dependent and/or frequency-dependent elasticity of fluids, such as, for example, polymer melts or solid bodies, such as plastics, for example. The viscoelasticity is characterized by a partly elastic, partly viscous behaviour. The material returns only incompletely to its initial state following the removal of an externally active force; the remaining energy is absorbed in the form of flow processes.

In connection with the description of the present invention, a gel should be understood to be a finely dispersed system comprising at least one first, frequently solid, and at least one second, frequently liquid, phase. A gel is frequently a colloid. The solid phase in this case forms a sponge-like, three-dimensional network, the pores of which are filled by a liquid or also by a gas. The two phases frequently penetrate one another completely during this. Particles or droplets which are finely distributed in another medium (solid, gas or liquid), i.e. the dispersion medium, are referred to as colloids.

According to a further preferred embodiment of the invention, an electrochemical energy store is provided, in which the extinguishing agent or the extinguishing agent additive is a solid or an elastically deformable material or is contained in such a material. The term “solid” should also include in this context pressed aggregates of powders or cellular materials, preferably elastically deformable cellular materials.

According to a further preferred embodiment of the invention, an electrochemical energy store is provided, in which the extinguishing agent or the extinguishing agent additive is disposed as spacers or edge protection plates between two adjacent electrochemical cells or between an electrochemical cell and a housing wall, in each case.

According to a further preferred embodiment of the invention, an electrochemical energy store is provided in which the extinguishing agent or the extinguishing agent additive can absorb or contains a multiple of its volume in water. Particularly preferable in this context are extinguishing agents based on gelling agents, preferably those containing extinguishing agent additives based on so-called super-absorbers.

According to a further preferred embodiment of the invention, an electrochemical energy store is provided in which the extinguishing agent or the extinguishing agent additive contains at least one polymer, preferably a copolymer, particularly preferably an acrylamide copolymer or a sodium acrylate copolymer.

According to a further preferred embodiment of the invention, an electrochemical energy store is provided in which the extinguishing agent or the extinguishing agent additive contains at least one fatty acid ester.

According to a further preferred embodiment of the invention, an electrochemical energy store is provided in which the extinguishing agent or the extinguishing agent additive contains a surfactant.

According to a further preferred embodiment of the invention, an electrochemical energy store is provided in which the extinguishing agent or the extinguishing agent additive contains at least a mixture or an emulsion of water and at least one fatty acid ester, at least one polymer, preferably a copolymer, particularly preferably an acrylamide copolymer or a sodium acrylate copolymer.

According to a further preferred embodiment of the invention, an electrochemical energy store is provided in which the extinguishing agent contains a mixture or an emulsion of approx. 28% of at least one polymer, approx. 6% of at least one surfactant, approx. 23% of at least one ester oil and approx. 43% water.

According to a further preferred embodiment of the invention, an electrochemical energy store is provided in which the extinguishing agent additive is used in connection with water and a mixture or an emulsion of approx. 50% of at least one polymer, approx. 10% of at least one surfactant and approx. 40% of at least one ester oil.

According to a further preferred embodiment, the carrier substance with which the extinguishing agent additive can be mixed to form an extinguishing agent, is a coolant, which flows through a coolant circuit which is closed when the energy store is operating normally and which is configured such that the coolant escapes from the closed coolant circuit at certain points in the event of a fire and is able to provide an extinguishing effect at these points. In this way, the extinguishing effect can be selectively provided at particular points which are affected by a fire; at the same time, the coolant effect can be retained.

A coolant within the meaning of the present invention should be taken to mean a flowable material, preferably a gaseous or liquid heat transport medium, which is able to absorb heat from its environment, transport this heat through flow and also deliver this heat into its environment, and is suitable, on account of its physical properties, for transporting heat through heat conduction and/or heat transport via aerodynamic or hydrodynamic flows, particularly also via convection currents, in the heat transport medium. Important examples of heat transport media generally used in the art are, for example, air or water or other customary coolants. Depending on the context of the application, other gases or fluids are also customary, such as chemically inert (low reactive) gases or liquids, such as noble gases or liquefied noble gases or substances with a high heat capacity and/or heat conductivity, for example.

A flowable material in this context should be understood to mean any material in which a flow can be created in the aerodynamic or hydrodynamic sense or in which a flow of this kind can be maintained. Examples of such materials are particularly gases and liquid. However, flows in this sense can also be sustained or can occur in a mixture of liquids or gases and finely distributed solids, so-called aerosols, or in colloidal solutions.

A particularly preferred device according to the invention comprises a means for stabilizing the coolant pressure where the coolant escapes from the coolant circuit at given points in the event of a fire. This embodiment of the invention may be connected to a largely extensive, or completely extensive, sustaining of the coolant pressure and therefore the cooling effect, when the coolant escapes from the cooling circuit at given points, so that its extinguishing effect can be deployed at these points.

The release of the coolant at given points in the event of a fire is preferably initiated by valves in this case with a preferably mechatronic or sensory trigger mechanism. It is thereby possible for an extinguishing agent to be selectively applied to a continuous cell in the event of a fire and thereby prevent the so-called cascade effect.

An exemplary embodiment of the invention is also preferred in which water is used as a coolant and in which this coolant flows through a cooling circuit which is closed when the energy store is operating normally, said coolant circuit being configured such that water can escape from the closed coolant circuit at given points in the event of a fire and, on emerging from the coolant circuit, is mixed with an extinguishing agent additive, whereupon a gel or a viscoelastic fluid is created.

Particularly preferable in this case is the use of an extinguishing agent additive consisting of a mixture of at least one polymer, at least one surfactant and at least one ester oil.

Further, particularly preferable is an additive consisting of a mixture of approx. 50% of at least one polymer, approx. 10% of at least one surfactant and approx. 40% of at least one ester oil.

When measuring the mixing proportions, it should preferably be taken into account that the advantageous effects of the cooling and extinguishing mixture or of the additive are based on the viscoelasticity of the cooling and extinguishing mixture and on its ability to bind water. The adhesive force of the coolant on smooth surfaces can thereby also be increased. The liquid does not flow away unused.

Particularly in the case of mixtures of polymers, ester oils, surfactants and water, a suitable measurement of the mixing ratios under the influence of kinetic energy leads to a significant reduction in viscosity compared with the resting stage. In this way, a mixture of this kind with a low viscosity can flow through a cooling circuit and at the same time exhibit a high viscosity when it emerges from the cooling circuit at the site of the fire. The flowability of such mixtures is therefore mainly dependent on the flow velocity.

Through the chemical-physical integration of the liquid into a gel structure, the liquid's evaporation rate may be significantly reduced, even at higher temperatures.

In this way, the liquid consumption can be significantly reduced. At the fire site, the liquid integrated into a gel structure can provide a greater cooling effect due to the comparatively high layer thickness and the reduced evaporation speed. This effect is particularly important when fighting fires at very high temperatures.

In a few preferred embodiments, the extinguishing agent additive preferably has the form of a mixture consisting of P % by wt. of at least one polymer, T % by wt. of at least one surfactant and E % by wt. of at least one ester oil, based on the total amount of the additive, wherein:

45≦P≦55,

8≦T≦12, and P+T+E=100

35≦E≦45

According to further preferred embodiments of the invention, it is provided that at least one heat-conducting or heat-transporting structure is inserted in at least one of the housing walls, internal housing walls or housing side walls. This may preferably be an arrangement of cooling ducts, heat conductors or heat pipes. In this way, it is possible to stabilize the operating temperature of the electrochemical cells and thereby contribute to the most efficient, safest operation possible of the electrochemical cells.

The heat-conducting or heat-transporting structures are preferably cooling ducts, wires or similar structures in comb form or in YO form, which are preferably arranged axially and in a splayed manner. It is possible to ensure by means of these preferred embodiments that the housing block or the entire arrangement is mechanically stabilized and held and that the cooling approaches the cells on the substance side and has the function of a supporting element with a vibration-damping effect. Preferred materials in this context are C fibres, copper, heat-conducting films or cooling ribs.

According to further preferred embodiments of the invention, it is provided that at least one of the housing walls, internal housing walls or housing side walls comprises a preferably gas-filled cavity. Cavities of this kind are preferably used to facilitate expansion of the electrochemical cells during operation and to accommodate the volume enlargement of the cells associated with this, in order to avoid or mitigate the detrimental effects of such volume increases in individual cells on adjacent cells.

According to the invention, there is further provided an arrangement with a plurality of flat electrochemical cells having a seal seam extending at least regionally along the edge of the cells and with a housing as described above. It is preferably provided in this case that the seal seams of the cells are inserted at least regionally and at least partially into the incisions in the housing walls and/or in the housing side walls.

According to further preferred embodiments of the arrangement according to the invention, it is provided that the cells are held in the housing by means of a frictional connection between the cells and at least one of the housing walls, internal housing walls or housing side walls.

According to the invention, there is further provided a method of producing a housing or an arrangement according to the invention, in which the housing is cut wholly or partially from a continuous section.

The features of the described embodiments and further embodiments of the invention may be advantageously combined with one another, so that the person skilled in the art is provided with further embodiments of the invention which cannot be definitively described in full here.

The invention is described in greater detail below with the help of figures. In the figures

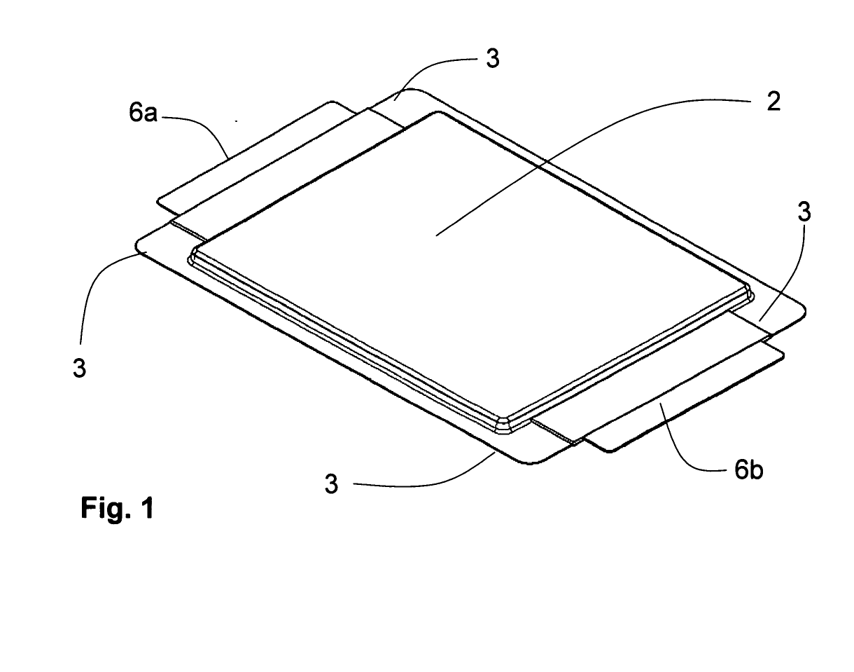

FIG. 1 shows a first embodiment of a flat electrochemical cell in schematic form;

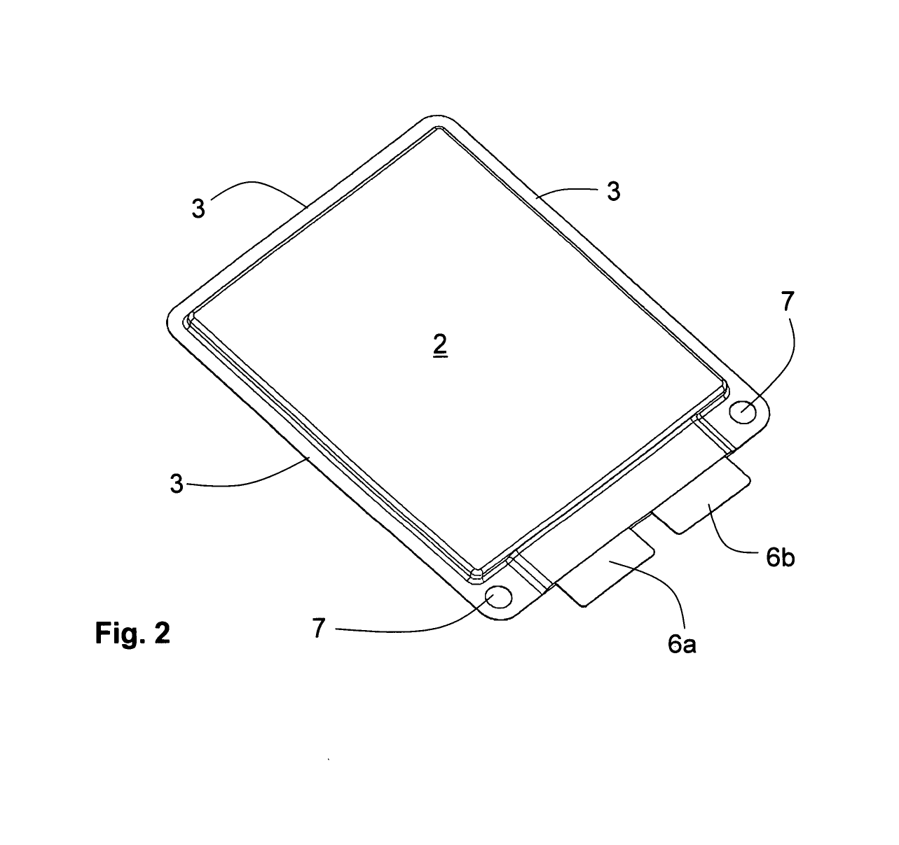

FIG. 2 shows a second embodiment of a flat electrochemical cell in schematic form;

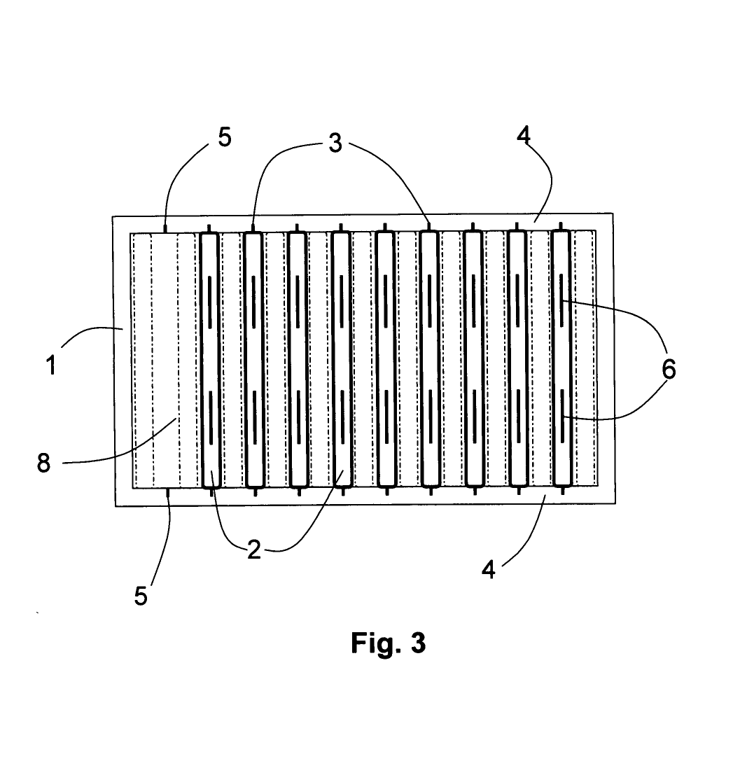

FIG. 3 shows an arrangement according to the invention of a plurality of electrochemical cells according to a preferred embodiment of the invention in schematic form;

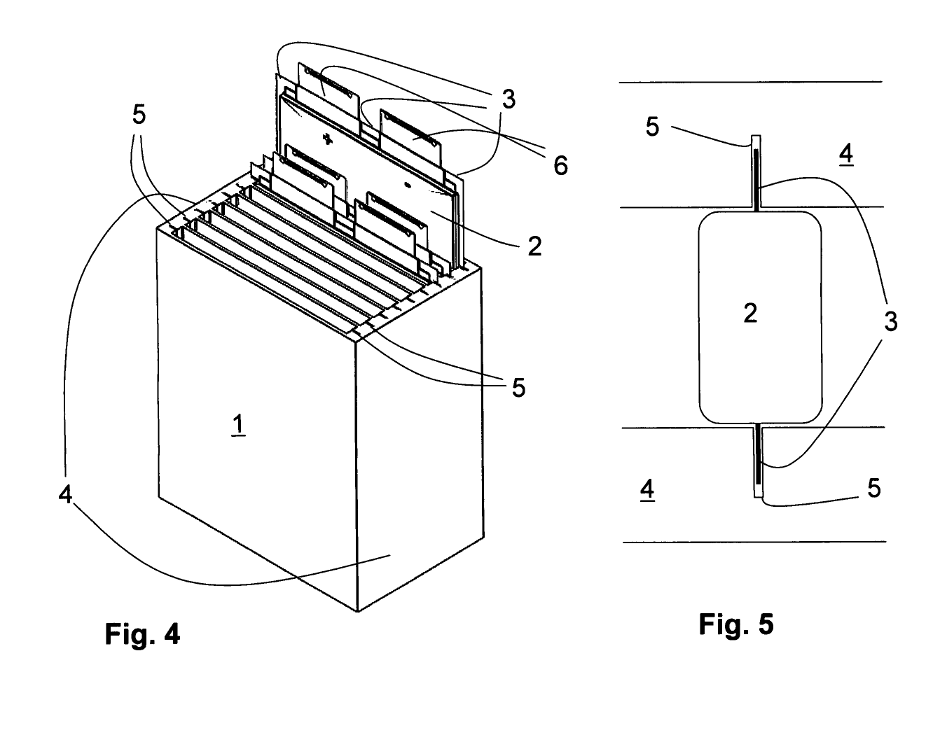

FIG. 4 shows a further preferred exemplary embodiment of an arrangement according to the invention in schematic form;

FIG. 5 shows a sectional view of a section of an arrangement according to the invention.

FIG. 1 shows an exemplary embodiment of a flat electrochemical cell 2 in schematic form in which the conductors 6a and 6b, in other words the electrical terminals of the cell, are fed out of the casing or packing of the cell at opposite sides thereof. The packing or casing of the electrochemical cell is sealed at the side with the help of a seal seam 3, which is formed by a hot-sealing step or similar process steps, for example, in which the plurality of layers of the packing film are connected to one another by a fusion joining process, so that a substance exchange between the inside of the electrochemical cell and its environment is practically impossible.

As shown in FIG. 1, the seal seam 3 is routinely substantially thinner than the actual body of the electrochemical cell. This means that the seal seam is suitable for being inserted into an incision in a housing wall of a housing according to the invention for accommodating one or a plurality of electrochemical cells of this kind.

FIG. 2 shows a further preferred exemplary embodiment of a flat electrochemical cell in schematic form, in which the conductors 6a and 6b are fed out of the edge of the casing or packing of the electrochemical cell at the same end. Since in this exemplary embodiment of the flat electrochemical cell, no conductors are fed out of the edge section of the cell 2 at the opposite end, the width of the seal seam 3 at this opposite end is narrower than it is at the end from which the conductors 6a and 6b are conducted. Therefore, not only the side regions of the seal seam 3, but also the region of the seal seam 3 situated opposite the conductors, are suitable for being inserted into an incision in a wall of a housing according to the invention. In the exemplary embodiment shown in FIG. 2, at the end of the cell in which the conductors are fed out of the edge section and at which the seal seam is correspondingly wider, circular apertures 7 through the seal seam are provided, which can be used to secure the cell.

The exemplary embodiment of the electrochemical cell shown in FIG. 1 is therefore primarily suitable for housing forms in which 2 housing side walls situated opposite one another of the housing according to the invention comprise incisions into which the seal seam 3 can be inserted, whereas the exemplary embodiment of an electrochemical cell shown in FIG. 2 is ideally suitable for insertion with its seal seam 3 not only into incisions in the two side walls, but also into an incision in the baseplate of a housing.

FIG. 3 shows an exemplary embodiment of a housing according to the invention in schematic form with two housing side walls 4 situated opposite one another which comprise incisions 5, into which the seal seams 3 of a plurality of electrochemical cells 2 with conductors 6 are inserted. Internal housing walls 8 are arranged between the electrochemical cells.

A perspective side view of a preferred exemplary embodiment of a housing 1 according to the invention is shown in schematic form in FIG. 4, in which electrochemical cells with the structure shown in FIG. 2, in which the conductors project from the wall section at the same end of the galvanic cell are inserted with their seal seams 3 into the incisions 5 in the housing side walls 4 of the housing 1.

FIG. 5 shows in schematic form an enlarged representation of a section of an arrangement according to the invention, in which an electrochemical cell 2 is inserted with its seal seams 3 into incisions 5 in two opposite housing side walls 4 of a housing.

The representations in the figures are preferably schematic and are particularly frequently not necessarily to scale.

The present invention and the exemplary embodiments thereof offer the advantageous possibility of dispensing with a framework structure for electromagnetic cells and instead inserting the cells with their seal seam straight into a housing according to the invention. It is also particularly advantageous in this case for the seal seam of the electrochemical cells to be preserved where there is a corresponding choice of housing material, which preferably comprises a compressible, elastic material, particularly preferably a cellular plastic material. This is made possible particularly in that with a small number of embodiments of the invention, the cell is held by a frictional connection over the entire surface and can thereby be additionally stress-relieved. Particularly those embodiments of the invention which rely on appropriate materials and/or on the possibility of using internal housing walls offer additional protection against mechanical action on the cells, for example the effects of unwanted vibrations.

When using a compressible material for the housing or housing walls, particularly housing side walls, housing baseplates or internal housing walls, preferably a cellular plastic, there is the advantageous possibility that the electrochemical cells are able to expand their volume without there being any risk of unwanted influences on adjacent cells or other kinds of damage as a result of this. Moreover, production tolerances in the manufacture of electrochemical cells can be effectively compensated by suitably designed exemplary embodiments of the invention. With an appropriate choice of material, considerable weight savings are possible compared with batteries in which the electrochemical cells are held by framework structures.

In the internal housing walls, with those embodiments which provide for such internal walls, wire elements, for example, can be inserted into these internal housing walls. This is particularly advantageously possible when the internal housing walls are made of a cellular plastic material. In addition to wire elements, however, other heat-conducting means or heat-transporting means can be inserted into the internal housing walls or also into other housing walls.

Insofar as the housing according to the invention or parts of this housing are made of cellular material, such cellular material blocks may be produced cost-effectively as a continuous product or line and cut to size where required.

1-12. (canceled)

13. A housing for accommodating at least one flat electrochemical cell, said cell having a seal seam extending at least sectionally along the edge of said cell, the housing comprising:
two housing side walls arranged substantially parallel to one another, which housing side walls are provided, in the mutually opposite inner surfaces thereof, with a pair of incisions situated opposite one another for each cell that is to be accommodated, said incisions being designed to accommodate the at least one seal seam of the particular cell,
wherein at least one of the housing walls, internal housing walls or housing side walls is produced at least partially from a compressible material.

14. The housing according to claim 13, wherein the compressible material is an elastic material.

15. The housing according to claim 13, wherein the housing comprises at least one housing wall disposed between the two housing side walls which comprises, in its inner surface, one incision for each cell to be accommodated, said incision being designed to receive the at least one seal seam of the respective cell.

16. The housing according to claim 13, wherein the housing comprises at least one internal housing wall which extends, in the area between two pairs of incisions situated opposite one another, at least partially between the two housing side walls.

17. The housing according to claim 13, wherein at least one of the housing walls, internal housing walls or housing side walls is produced at least partially from a cellular material.

18. The housing according to claim 17, wherein the cellular material is a polyethylene expanded plastic.

19. The housing according to claim 13, wherein at least one of the housing walls, internal housing walls or housing side walls is provided with at least one fire-retardant additive, extinguishing agent and/or extinguishing agent additive.

20. The housing according to claim 13, wherein at least one heat-conducting or heat-transporting structure is arranged in at least one of the housing walls, internal housing walls or housing side walls.

21. The housing according to claim 13, wherein at least one of the housing walls, internal housing walls, or housing side walls comprises at least one cavity.

22. The housing according to claim 21, wherein the at least one cavity is gas-filled.

23. An arrangement comprising:
a plurality of flat electrochemical cells having a seal seam extending at least regionally along the edge of the cells; and
a housing according to claim 13, the housing accommodating the plurality of cells.

24. The arrangement according to claim 23, wherein the seal seams of the cells are disposed at least regionally and at least partially into the incisions in the housing walls and/or in the housing side walls.

25. The arrangement according to claim 23, wherein the cells are held in the housing by means of a frictional connection between the cells and at least one of the housing walls, internal housing walls or housing side walls.

26. A method of producing a housing according to claim 13, comprising:
cutting the housing wholly or partially from a continuous section.
